(19) United States
(12) Patent Application Publication
(10) Pub. No.: US 2017/0021482 A1
(43) Pub. Date: Jan. 26, 2017

(54) SEAL REMOVAL TOOL

(71) Applicant: Caterpillar Inc., Peoria, IL (US)

(72) Inventors: Mario Cuellar, Nuevo Laredo (MX); Jesus N. Flores, Nuevo Laredo (MX); Porfirio L. Gutierrez, Nuevo Laredo (MX); Felix Ovalle, Nuevo Laredo (MX); David O. Villarreal, Nuevo Laredo (MX)

(73) Assignee: Caterpillar Inc., Peoria, IL (US)

(21) Appl. No.: 15/289,643

(22) Filed: Oct. 10, 2016

(51) Int. Cl. B25B 27/00; B25B 27/14

(52) U.S. Cl. CPC B25B 27/0028; B25B 27/14

(57) ABSTRACT

The disclosure provides a seal removal tool for removing a seal member from a grooved surface of a mechanical component. The seal removal tool includes a handle and a tool member. The tool member includes a first portion, a second portion, a third portion, and a fourth portion. The first portion is attached to and extends from the handle along a longitudinal axis of the handle. The second portion extends from the first portion. The second portion is inclined at a first angle relative to the first portion. The third portion extends from the second portion. The third portion is inclined at a second angle relative to the second portion. The fourth portion extends from the third portion. The fourth portion is inclined at a third angle relative to the third portion. The fourth portion has a curved tip portion.

### TECHNICAL FIELD

The present disclosure generally relates to a seal removal tool. More particularly, the present disclosure relates to the seal removal tool for removal of seal members from annular grooves of a machine component.

### BACKGROUND

Machine components, such as fuel injectors, are commonly known to employ a number of seal members. For example, a fuel injector employs a number of seal members, to facilitate a fluid seal arrangement between the fuel injector and a mating component. Typically, a seal member is positioned within an annular groove of the fuel injector. The annular groove may be either of an interior annular groove or an exterior annular groove. During remanufacturing of the fuel injector, the seal member may require to be removed from the annular groove of the fuel injector. A seal removal tool is generally employed to remove the seal member from the annular groove of the fuel injector.

Conventionally, the seal removal tool includes a handle and a tool member. The tool member is typically an elongated cylindrical member with a pointed tip portion. In order to remove the seal member from the annular groove, the seal removal tool accesses the annular groove, such that the pointed tip portion of the seal removal tool engages with the seal member. Thereafter, the seal member is pulled out of the annular groove. However, for removal of the seal member positioned in the interior annular groove of the fuel injector, it may be cumbersome for such seal removal tools to access the interior annular groove. Additionally, the pointed tip portion of such seal removal tools may cause finger pricking to a service personnel, during the seal removal process. Therefore, the seal removal process requires a skilled service personnel. Accordingly, there exists a need for improved seal removal tool, which facilitates relatively easy removal of the seal member from the annular groove of the fuel injector.

### SUMMARY OF THE DISCLOSURE

Various aspects of the present disclosure provide a seal removal tool for removing a seal member from a grooved surface of a mechanical component. The seal removal tool has a handle and a tool member. The handle has a longitudinal axis. The tool member includes a first portion, a second portion, a third portion, and a fourth portion. The first portion is attached to and extends from the handle along the longitudinal axis. The second portion extends from the first portion. The second portion is inclined at a first angle relative to the first portion. The third portion extends from the second portion. The third portion is inclined at a second angle relative to the second portion. The fourth portion extends from the third portion. The fourth portion is inclined at a third angle relative to the third portion. The fourth portion has a curved tip portion.

### BRIEF DESCRIPTION OF THE DRAWINGS

FIG. 1 is a partial perspective view of a seal removal tool being operated to remove a seal from a fuel injector, in accordance with the concepts of the present disclosure;

FIG. 2 is a perspective view of the seal removal tool of FIG. 1, in accordance with the concepts of the present disclosure; and

FIG. 3 is an enlarged view of a tool member of the seal removal tool of FIG. 2, in accordance with the concepts of the present disclosure.

### DETAILED DESCRIPTION

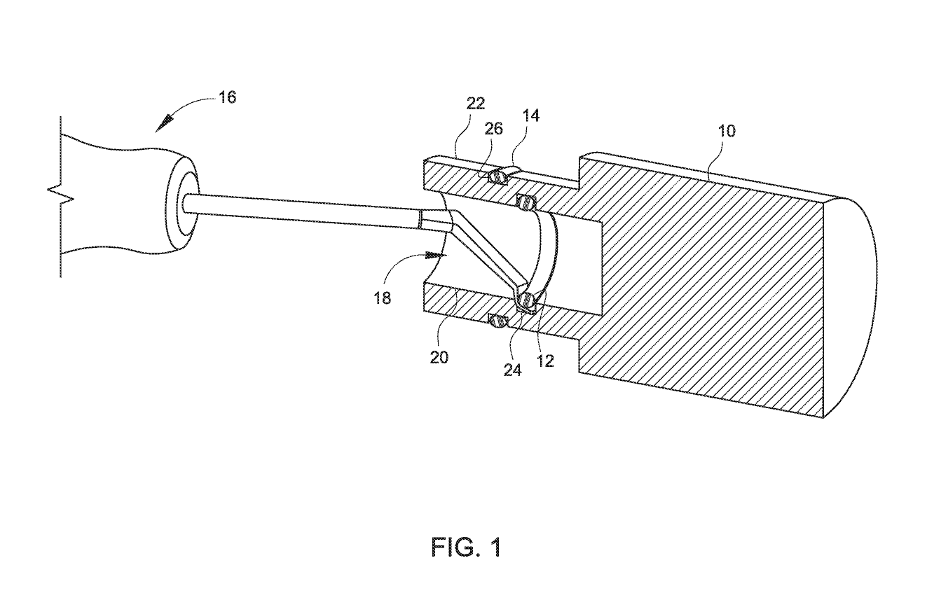

Referring to FIG. 1, there is shown a sectional view of a mechanical component 10 that supports an inner seal member 12 and an outer seal member 14. Additionally, a partial view of a seal removal tool 16, which is engaged to remove the inner seal member 12 and the outer seal member 14 from the mechanical component 10, is shown in FIG. 1. In an embodiment, the mechanical component 10 is a fuel injector 10. Hereinafter the mechanical component 10 may be interchangeably referred to as the fuel injector 10, without departing from the scope of this disclosure. Although, concepts of the present disclosure are described as applied to the fuel injector 10, applicability to various other types of the mechanical component 10 may also be contemplated. Examples of the mechanical component 10 include, but are not limited to, a spark plug, a piston, a solenoid valve, and a tube fitting. Applicability to various other electrical components and hydraulic components employing seal members, may also be contemplated.

The fuel injector 10 is engaged to inject fuel in a combustion chamber (not shown) of an engine (not shown). The fuel injector 10 includes an opening 18, an inner surface 20, and an outer surface 22. The inner surface 20 and the outer surface 22 includes an interior annular groove 24 and an exterior annular groove 26, respectively. In an embodiment, the interior annular groove 24 and the exterior annular groove 26 are annular indentations made into the inner surface 20 and the outer surface 22, respectively. Further, the interior annular groove 24 and the exterior annular groove 26 are shaped and sized to facilitate positioning of the inner seal member 12 and the outer seal member 14, respectively.

The inner seal member 12 and the outer seal member 14 provide a radial sealing between the fuel injector 10 and a number of mating components (not shown). In an embodiment, each of the inner seal member 12 and the outer seal member 14 is an O-ring annular seal formed from an elastomeric material. Although, the present disclosure describes O-ring annular seal as the inner seal member 12 and the outer seal member 14, various other types of annular seals for the inner seal member 12 and the outer seal member 14 may also be contemplated. Examples of the other annular seals include, but are not limited to, X-ring seal, C-ring seal, D-ring seal, lip seal, and square shaped ring seal.

The seal removal tool 16 is engaged to remove the inner seal member 12 and the outer seal member 14 from the fuel injector 10. For ease in reference, the seal removal tool 16 will be described to remove the inner seal member 12 from the interior annular groove 24, hereinafter. Similarly, the seal removal tool 16 may also remove the outer seal member 14 from the exterior annular groove 26 of the fuel injector 10. The seal removal tool 16 is inserted beneath the inner seal member 12 to displace the inner seal member 12 from the interior annular groove 24. Once the inner seal member 12 is de-seated from the interior annular groove 24, the inner seal member 12 is pulled out to remove from the fuel injector 10.

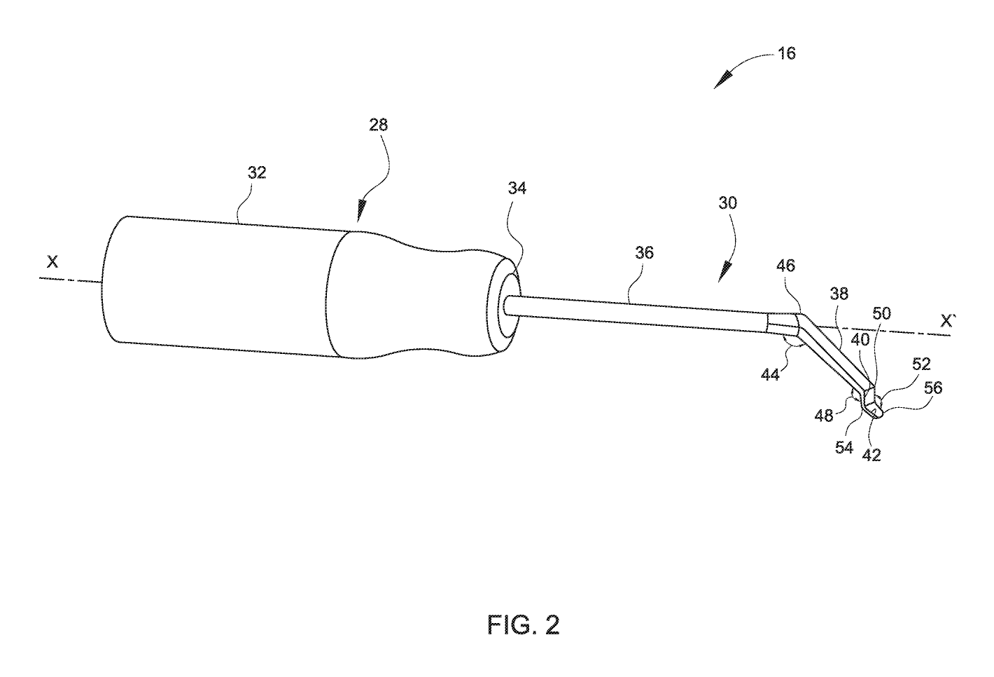

Referring to FIG. 2, there is shown a perspective view of the seal removal tool 16. The seal removal tool 16 is employed to remove the inner seal member 12 from the interior annular groove 24 of the fuel injector 10. The seal removal tool 16 includes a handle 28 and a tool member 30.

The handle 28 is structured to facilitate the service personnel to hold the seal removal tool 16. The handle 28 includes a grip surface 32 and an end face 34. The grip surface 32 extends along a longitudinal axis X-X′ of the handle 28. The service personnel generally hold the seal removal tool 16, at the grip surface 32 of the handle 28.

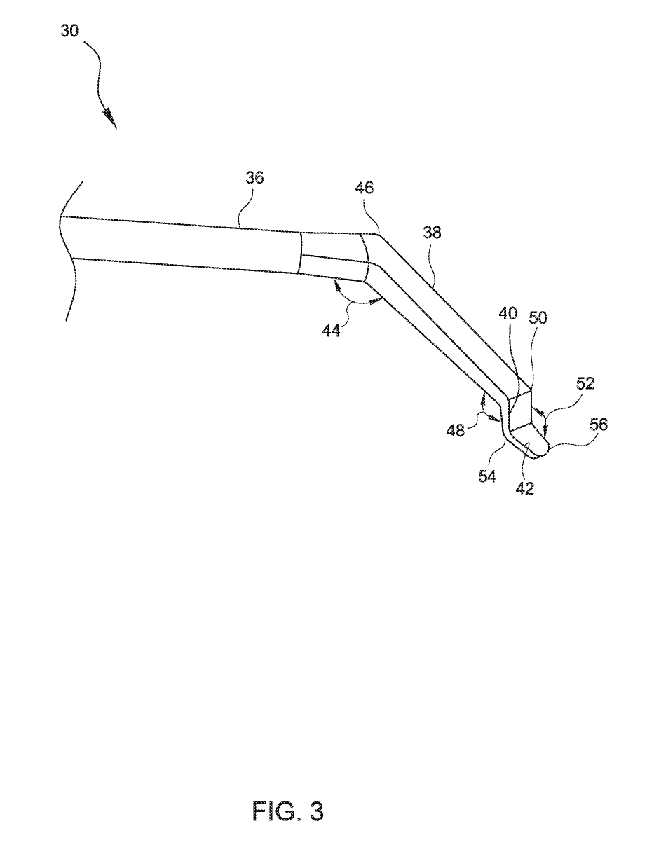

Referring to FIGS. 2 and 3, there is shown the tool member 30. The tool member 30 is fixedly attached and extends outwards from the end face 34 of the handle 28. The tool member 30 includes a first portion 36, a second portion 38, a third portion 40, and a fourth portion 42. The first portion 36, the second portion 38, the third portion 40, and the fourth portion 42 are sequentially extended to form the tool member 30.

The first portion 36 of the tool member 30 is an elongated shank fixedly attached to the end face 34 of the handle 28. More particularly, the first portion 36 extends from the handle 28, along the longitudinal axis X-X′. An attachment means between the first portion 36 and the end face 34 includes, but is not limited to, a weld attachment, an adhesive attachment, a fit attachment, and a screw type attachment.

The second portion 38 of the tool member 30 is an arm portion that can be inserted in the opening 18 of the fuel injector 10, to access the inner seal member 12. The second portion 38 is tapered in shape. The second portion 38 extends from the first portion 36. More particularly, the second portion 38 is inclined to the first portion 36 at a first angle 44, to form a first bend 46 with the first portion 36.

The third portion 40 is a tapered section extending from the second portion 38 of the tool member 30. The third portion 40 is inclined to the second portion 38 at a second angle 48. More specifically, the third portion 40 is inclined to the second portion 38, to form a second bend 50 with the second portion 38.

The fourth portion 42 of the tool member 30 engages with the inner seal member 12, to de-seat the inner seal member 12 from the interior annular groove 24. The fourth portion 42 extends from the third portion 40. The fourth portion 42 is inclined to the third portion 40 at a third angle 52. More specifically, the fourth portion 42 is inclined to the third portion 40, to form a third bend 54 with the third portion 40. The fourth portion 42 has a curved tip portion 56, which is slid beneath the inner seal member 12. Notably, the first portion 36, the second portion 38, the third portion 40, and the fourth portion 42 are positioned, such that the first angle 44, the second angle 48, and the third angle 52 are non co-planar.

### INDUSTRIAL APPLICABILITY

In operation, the seal removal tool 16 disclosed herein is employed to remove the inner seal member 12 and the outer seal member 14 from the fuel injector 10. The seal removal tool 16 includes the first portion 36, the second portion 38, the third portion 40 and the fourth portion 42. As shown in FIG. 2, each of the first portion 36, the second portion 38, the third portion 40 and the fourth portion 42 are consecutively extended to form the tool member 30.

In order to remove the inner seal member 12 positioned within the interior annular groove 24, the second portion 38 of the seal removal tool 16 may be inserted inside the opening 18 of the fuel injector 10. Afterwards, the curved tip portion 56 of the fourth portion 42 is slid beneath the inner seal member 12 and adjusted to displace the inner seal member 12 from the interior annular groove 24. Further, the inner seal member 12 may be pulled through the opening 18 to remove the inner seal member 12 from the opening 18.

In order to remove the outer seal member 14 from the exterior annular groove 26, the curved tip portion 56 is slid beneath the outer seal member 14 and moved upwards. The tool member 30 is moved along the circumference and the aforesaid step is repeated till the outer seal member 14 is displaced from the exterior annular groove 26.

Furthermore, as the second portion 38 is inclined to the first portion 36 at an inclination of the first angle 44. The inclination enables the service personnel to access the inner seal member 12 through the opening 18 with relatively lesser effort. Additionally, since the fourth portion 42 extends outwards from the third bend 54, the fourth portion 42 facilitates relatively easy displacement of the inner seal member 12 from the interior annular groove 24.

The curved tip portion 56 of the fourth portion 42 of such seal removal tool 16 facilitates relatively easy insertion of the fourth portion 42 beneath the inner seal member 12. Thus, the tool member 30 of such seal removal tool 16 reduces time and effort involved in a seal removal process as compared to conventional tool members. Also, the curved tip portion 56 precludes any circumstances of finger pricking.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claim(s) and any equivalents thereof.

What is claimed is:

1. A seal removal tool for removing a seal member from a grooved surface of a mechanical component, the seal removal tool comprising:
a handle including a longitudinal axis; and
a tool member including:
a first portion attached to and extending from the handle along the longitudinal axis;
a second portion extending from the first portion, the second portion being inclined at a first angle relative to the first portion;
a third portion extending from the second portion, the third portion being inclined at a second angle relative to the second portion; and
a fourth portion extending from the third portion, the fourth portion including a curved tip portion and being inclined at a third angle relative to the third portion.
